(19) United States
(12) Patent Application Publication
(10) Pub. No.: US 2025/0025950 A1
(43) Pub. Date: Jan. 23, 2025

(54) APPARTUS FOR SUPPORTING SAW ASSEMBLIES

(71) Applicant: ELITE BUILDING GROUP INC., Bolton (CA)

(72) Inventor: Gregorio PANNIA, Brampton (CA)

(21) Appl. No.: 18/711,574

(22) PCT Filed: Sep. 7, 2022
(86) PCT No.: PCT/CA2022/051339

§ 371 Date: May 17, 2024

Related U.S. Application Data
(60) Provisional application No. 63/280,998, filed on Nov. 18, 2021.

(51) Int. Cl. B23D 47/02; B23D 45/00; B23D 45/02; B23D 47/04

(52) U.S. Cl. CPC B23D 47/02; B23D 45/003; B23D 45/021; B23D 47/04

(57) ABSTRACT

An apparatus for supporting a saw assembly for cutting a workpiece, comprising: a main frame supporting a translatable frame translatable longitudinally for releasably supporting the saw assembly such that at least a portion of a saw extends below the translatable frame into an interior space; a first support positioned for supporting at least a portion of a first edge of the workpiece; and a second support generally parallel to the first support for supporting at least a portion of a second edge of the workpiece and moveable laterally between (i) a retracted position and (ii) a plurality of extended positions, each extended position between the retracted position and the first support. The saw when activated and translated longitudinally over the interior space cuts the workpiece while the at least the portions of the first and second edges of the workpiece are at rest upon the first and second supports.

### FIELD

The present disclosure relates generally to construction tools and, more particularly, to apparatuses for supporting saw assemblies.

### BACKGROUND OF THE DISCLOSURE

On a construction job site, the cutting of certain materials may present various challenges. In particular, structured workpieces that have significant depth and/or internal structural elements, such as insulated concrete form (ICF) blocks, may be especially challenging to cut. ICF blocks typically comprise two foam panels held in spaced apart relation by a plurality of plastic or metal spacers or ribs. In some cases, the spacers may be hinged so that the panels can be collapsed together for storage or shipping.

Various methods may be used to cut ICF blocks along their lengths. In some cases, a circular saw may be used to cut one panel of an ICF block, which may or may not include cutting a portion of the spacers or ribs. The ICF block may then be turned over to try to cut the other panel; however, stability of the ICF block may then be compromised, which may make it more challenging, and dangerous, to cut the other panel. In some cases, further interior cutting by hand, such as with a reciprocating saw, may then be needed. If a conventional table saw is used, safety guards may need to be removed, compromising operator safety, and the cutting depth may be insufficient for larger ICF blocks; further still, the interior structure or ribs may still need to be cut by hand.

### SUMMARY OF THE DISCLOSURE

In an aspect there is provided an apparatus for supporting a saw assembly for cutting a workpiece. The apparatus comprises: a main frame supporting a translatable frame such that the translatable frame is translatable longitudinally along the main frame, the translatable frame for releasably supporting the saw assembly such that at least a portion of a saw of the saw assembly extends below the translatable frame and into an interior space of the main frame such that the saw assembly supported by the translatable frame is translatable longitudinally over the interior space with a cutting plane of the saw generally parallel to a longitudinal axis of the apparatus; a first support extending longitudinally and positioned for supporting at least a portion of a first edge of the workpiece; a longitudinally extending second support generally parallel to the first support for supporting at least a portion of a second edge of the workpiece and moveable laterally between (i) a retracted position at which the second support is farthest from the first support, and (ii) a plurality of extended positions, each extended position between the retracted position and the first support. The saw when activated and translated longitudinally over the interior space cuts the workpiece while the at least the portion of the first edge and the at least the portion of the second edge of the workpiece are at rest upon the first support and the second support.

In another aspect there is provided an apparatus for supporting a saw assembly for cutting a workpiece. The apparatus comprises: a main frame supporting a first track and a second track, the first track and the second track spaced apart from one another; a first support extending adjacent at least a portion of a length of the first track, at least a portion of the first support projecting into an interior space of the main frame for supporting at least a portion of a first edge of the workpiece, the first support adjacent and at least partially below an interior edge of the main frame; a second support generally parallel to the first support and extending adjacent at least a portion of a length of the second track, the second support for supporting at least a portion of a second edge of the workpiece and moveable laterally between (i) a retracted position at which the second support is farthest from the first support, and (ii) a plurality of extended positions, each extended position between the retracted position and the first support; a locking assembly for releasably locking the second support in either the retracted position or any of the plurality of extended positions; and a translatable frame for releasably supporting the saw assembly such that at least a portion of a saw of the saw assembly extends below the translatable frame and into the interior space, the translatable frame translatably engaged with the first track and the second track such that the saw assembly supported by the translatable frame is translatable longitudinally over the interior space. The saw when activated and translated longitudinally over the interior space cuts the workpiece while the at least the portion of the first edge and the at least the portion of the second edge of the workpiece are at rest upon the first support and the second support.

Other technical advantages may become readily apparent to one of ordinary skill in the art after review of the following figures and description.

### BRIEF DESCRIPTION OF THE DRAWINGS

For a better understanding of the various aspects described herein and to show more clearly how they may be carried into effect, reference will now be made, by way of example only, to the accompanying drawings in which:

FIG. 1A depicts a perspective view of an example workpiece;

FIG. 1B depicts a front view of the workpiece shown in FIG. 1A;

FIG. 2A depicts a side perspective view of an example apparatus;

FIG. 2B depicts a front perspective view of an example apparatus;

FIG. 3A depicts side perspective view of the apparatus shown in FIG. 2B;

FIG. 3B depicts a rear perspective view of the apparatus shown in FIGS. 2B and 3A;

FIG. 4 depicts a bottom perspective view of the apparatus shown in FIGS. 2B-3B;

FIG. 5 depicts a front view of the apparatus shown in FIGS. 2B-4, supporting an ICF block;

FIG. 6 depicts a partial view of the apparatus shown in FIGS. 2B-5, showing an example releasable locking structure;

FIG. 7 depicts a rear perspective view of another example apparatus, supporting another ICF block;

FIG. 8 depicts a partial front view of the apparatus shown in FIG. 7;

FIG. 9 depicts a partial front perspective view of the apparatus shown in FIG. 7;

FIG. 10 depicts a bottom perspective view of the apparatus shown in FIG. 7;

FIG. 11 depicts another bottom perspective view of the apparatus shown in FIG. 7, supporting yet another ICF block;

FIG. 12 depicts a partial bottom perspective view of the apparatus shown in FIG. 11;

FIG. 13 depicts another partial bottom perspective view of the apparatus shown in FIG. 11, supporting yet a further ICF block; and

FIG. 14 depicts another partial bottom perspective view of the apparatus shown in FIG. 13.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the aspect(s) described herein. However, it will be understood by those of ordinary skill in the art that the aspects described herein may be practiced without these specific details. In other instances, well-known methods, procedures and components have not been described in detail so as not to obscure the aspects described herein. It should be understood at the outset that, although exemplary aspects are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other aspects. Further definitions for terms may be set out herein; these may apply to prior and subsequent instances of those terms, as will be understood from a reading of the present description.

The indefinite article “a” is intended to not be limited to meaning “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

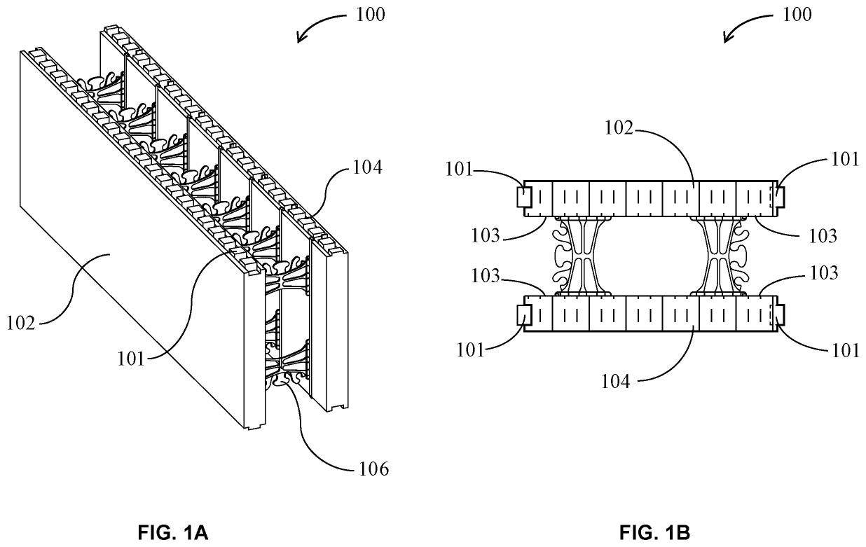

Reference is first made to FIG. 1, which shows an example workpiece 100, which may comprise a structured workpiece (which may comprise any workpiece made up of two or more interconnecting components). The example structured workpiece in this illustration is an insulated concrete form (ICF) block 100. ICF blocks 100 are examples of structured workpieces 100 which may be used with the apparatus 200 described herein. An ICF block 100 may be formed from two foam panels 102, 104. In the example shown in FIG. 1, the foam panels 102, 104 are 8 feet long, 18 inches high, and 2⅝ inches thick. The ICF block 100 may include a plurality of spacers 106 connected to the foam panels 102, 104 by a rib embedded in each foam panel 102, 104 and a web spacing the ribs apart, so as to create a void or space between the panels 102, 104 into which concrete may be poured. Each panel 102, 104 of the ICF blocks 100 may comprise a plurality of protrusions or “nipples” 101 which cooperatively mate or engage with protrusions 101 on an abutting ICF block 100 when the ICF blocks 100 are stacked atop one another vertically (the vertical arrangement of an ICF block 100 shown in FIG. 1A), to create a form into which concrete may be poured for a concrete foundation wall, for example. In the example shown in FIG. 1, the web may be connected to the ribs by hinges so that the ICF block 100 may be collapsed for storage or transport. In some cases, the web is not hinged and the panels 102, 104 are held fixed in spaced relation by spacers 106. The spacers 106 may be metal or any other suitable material. For example, the ribs and/or web forming the spacers 106 may be formed from a hard plastic, metal, or a combination thereof. The web may be of a size sufficient to space the foam panels 102, 104 to create a 6″ spacing between the interior faces of the panels 102, 104, and an overall ICF block 100 depth of 11¼ inches. It will be appreciated that the ICF block 100 shown in FIG. 1 is one example only of a workpiece that may be used with the apparatus 200 described herein, and other examples may have different lengths, heights, depths, thicknesses, and/or configurations (including ICF blocks 100 that are straight, curved, include one or more bends of any degree (including a 90° bend and a 45° bend, for example), include a “T”, include one or more tapered panel(s) 102, 104, include only one foam panel, include one or both panels 102, 104 having shapes other than that shown in FIG. 1 (such as panel(s) 102, 104 shaped to provide a brick ledge), and/or any combination of the foregoing). Any suitable type of workpiece 100, such as structured workpieces 100 (including ICF blocks 100), of any material cuttable by saws 107 usable with the apparatus 200 (including metal, wood, plastic, and any other material cuttable by saw assemblies usable with the apparatus 200, including saw assemblies having diamond blade saws 107), may be used with the presently described apparatus 200.

As will be appreciated, the ICF block 100 is an example of a structured workpiece 100 that poses the aforementioned challenges in cutting due to its relatively large depth as well as its interconnecting components.

In some cases, ICF blocks 100 need to be cut if the construction calls for a wall height that does not correspond to an integer multiple of the height of the ICF block 100. If the ICF block 100 is turned to lay on its side, an operator may try to use a circular saw to cut along the length of one of the panels 102, 104, but must also cut through the ribs and, in some cases, portions of the web. The ICF block 100 may need to be turned over to make a corresponding cut in the other side; however, at this point the structural stability of the ICF block 100 may be compromised and worker safety may be at risk. The ICF block 100 may also not be cut by a conventional table saw without removing some safety guides or protection, or without encountering the similar issues with compromised structural stability of the ICF block 100 during cutting.

Many conventional handheld circular saws and table saws may also have a blade depth insufficient to cut through some ICF panels, depending on the thickness of the panels. Some circular saws and/or table saws may encounter problems if required to cut the spacers 106, particularly if metal.

The present application describes an apparatus 200 for supporting a saw assembly that includes a saw 107 for cutting workpieces 100, including structured workpieces 100 such as ICF blocks 100. An abstract version of the saw assembly is shown in the figures, by reference only to the saw 107 of the saw assembly. Any suitable saw assembly may be used with the presently described aspects, including but not limited to portable carpentry chainsaws and circular saws (such as those made by Skil™ and Makita™, including 16″ models (e.g., a 16″ circular saw 107 would be required to cut through 4″ thick panels 102, 104 of an ICF block 100), as well as circular saws modified with chainsaw adapters (such as those made by Prazi™) which may allow for the circular saws to cut to depths of, e.g., 15″ to 20″. The apparatus 200 may be dimensioned to accommodate saws 107, or cutting depths, of various sizes. In some aspects, the saw assembly used with the apparatus 200 may comprise a diamond blade for cutting an ICF block 100 that includes, e.g., spacers 106 that comprise steel.

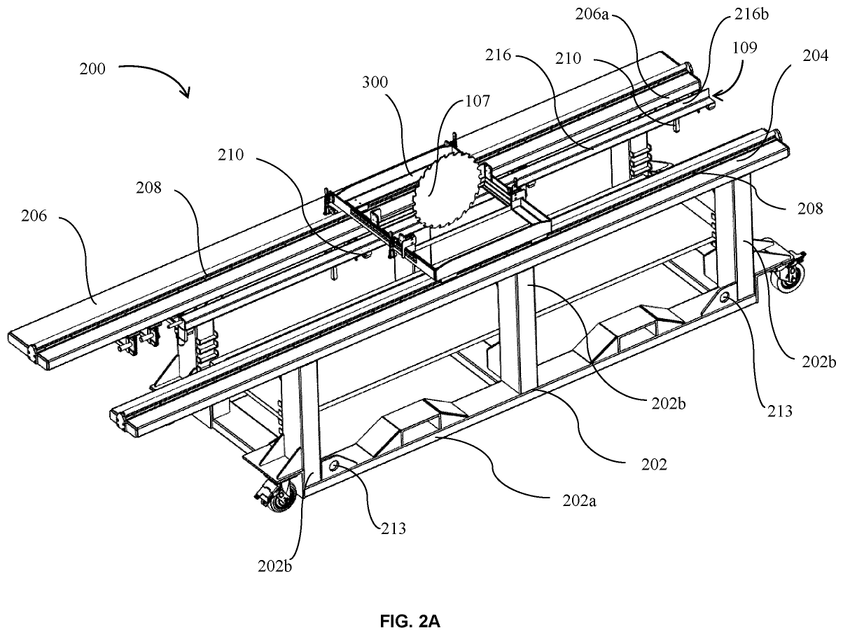

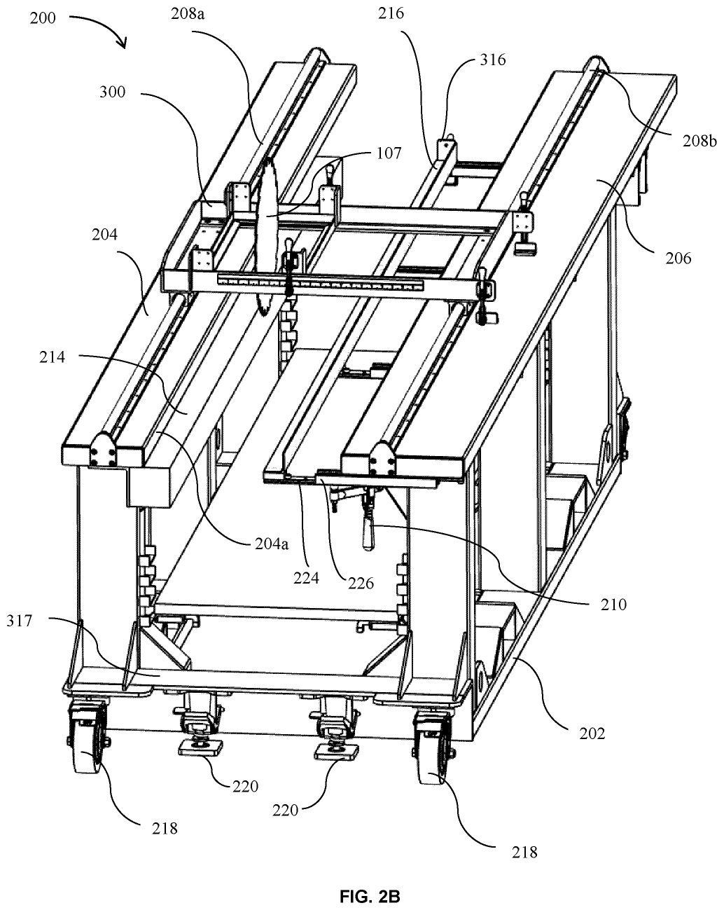

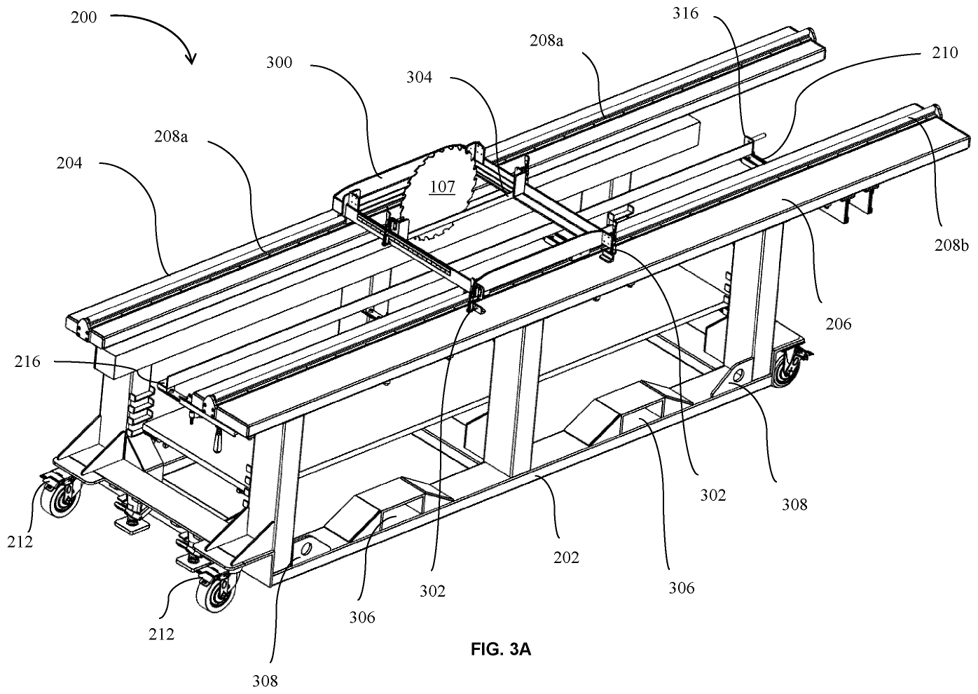

With reference to FIGS. 1-5, the apparatus 200 may support a saw assembly for cutting a workpiece 100, and may comprise a main frame 202 supporting one or more tracks 208, such as a first track 208a and a second track 208b. The first track 208a and the second track 208b may be spaced apart from one another. The apparatus 200 may further comprise a first beam 204 and a second beam 206 (which may comprise part of the main frame 202), which may respectively support the first and second tracks 208a, 208b (as described in further detail below), and which may be parallel and spaced apart. The main frame 202 may comprise a base 202a supporting generally upright legs or posts 202b and the first beam 204 and second beam 206. While FIGS. 2A-5 show a main frame 202 having a generally rectangular side profile and a generally square front and rear profile, it will be appreciated that the main frame 202 may comprise any suitable configuration for achieving the presently described aspects (as an example only, the legs 202b may be tapered inward from the base 202a to form a main frame 202 with a generally triangular front and rear profile and a generally rectangular side profile). In some aspects, the first beam 204 and the second beam 206 may be formed from metal. In some aspects, the first beam 204 and second beam 206 may each comprise 2×6 inch beam, 2×8 inch beam, or some other size beam. In an example, the first beam 204 may be a 2×6 inch metal beam and the second beam 206 may be a 2×8 inch metal beam.

As described above, each of the first beam 204 and the second beam 206 (such as upper surfaces thereof) may support a track 208 therein or thereon, and the tracks 208 may be supported along the respective lengths (or portions thereof) of the first beam 204 and the second beam 206. In some aspects, the main frame 202 itself, such as the first beam 204 and the second beam 206, may form the tracks 208 (e.g., such as by grooves formed in the first beam 204 and the second beam 206). The tracks 208 may allow for the translation (such as by sliding or rolling, as examples only) of a translatable frame 300 along their lengths, as further described below.

The apparatus 200 may further comprise a first support 214 (which may comprise a support beam 214) extending adjacent at least a portion of a length of the first track 208a. At least a portion of the first support 214 may project into an interior space 105 of the main frame 202, for supporting (such as by an upper surface 214a thereof) at least a portion of a first edge 103 (which may comprise a lateral edge 103) of the workpiece 100. The first support 214 may be attached to and below the first beam 204, and may be adjacent and at least partially below an interior edge 204a of the main frame 202, as best illustrated in FIG. 2B. The support beam 214 in the example shown may be secured to the first beam 204 by way of one or more metal brackets. In some examples, the first support 214 may comprise a support beam 214 that is formed from a material that is cuttable by the saw 107; for example, the support beam 214 may be made of a rigid but cuttable material, such as wood or a hard plastic, into which a cutting blade or saw 107 may saw without substantially damaging the blade and/or compromising the cutting operation. Furthermore, the support beam 214 may be replaceable. That is, the first support 214 (such as the support beam 214) may be releasably attached (such as by way of metal brackets fastened to the main frame 202 by way of one or more screws or other removable fasteners). As will be described further below, cutting of a portion of the workpiece 100 may, in some cases, involve cutting in close proximity to an interior edge 204a of the first beam 204 (see, e.g., FIG. 2B), in which cases the cutting blade or saw 107 may score into the support beam 214, which may necessitate occasional replacement of the first support or support beam 214.

The support beam 214 may comprise, for example, a 4×4 inch beam. The support beam 214 may be attached to the first beam 204 by way of metal brackets such that at least half of the width of the support beam 214 is exposed beyond the inner face or interior edge 204a of the first beam 204. For example, in some instances, such as where a 4×4 inch support beam 214 is used, 2 to 2½ inches of the width of the upper surface of the support beam 214 may be exposed, or extend beyond the interior edge 204a of the first beam 204. This exposed portion of the first support 214 (e.g., a support beam 214) may be available to support a lateral edge 103 of a workpiece 100, such as a structured workpiece 100 (including an ICF block 100), such as by an upper surface 214a of the first support 214.

The apparatus 200 may further comprise a second support 216 that is generally parallel to the first support 214 and which may extend adjacent at least a portion of a length of the second track 208b. The second support 216 may support at least a portion of a second edge 103 of the workpiece 100 (such as by an upper surface or horizontal face 216a thereof), and in some aspects, the second support 216 may be moveable laterally between (i) a retracted position (shown, e.g., in FIG. 2A) at which the second support 216 is at its farthest from the first support (such as the support beam) 214 (e.g., when the second support 216 is proximate the second beam 206), and (ii) a plurality of extended positions (one example of which is shown in FIGS. 2B-5), each extended position being between the retracted position and the first support (such as the support beam) 214 so as to be in closer proximity to (or in some examples in abutting relation with) the first support (such as the support beam) 214 than the retracted position.

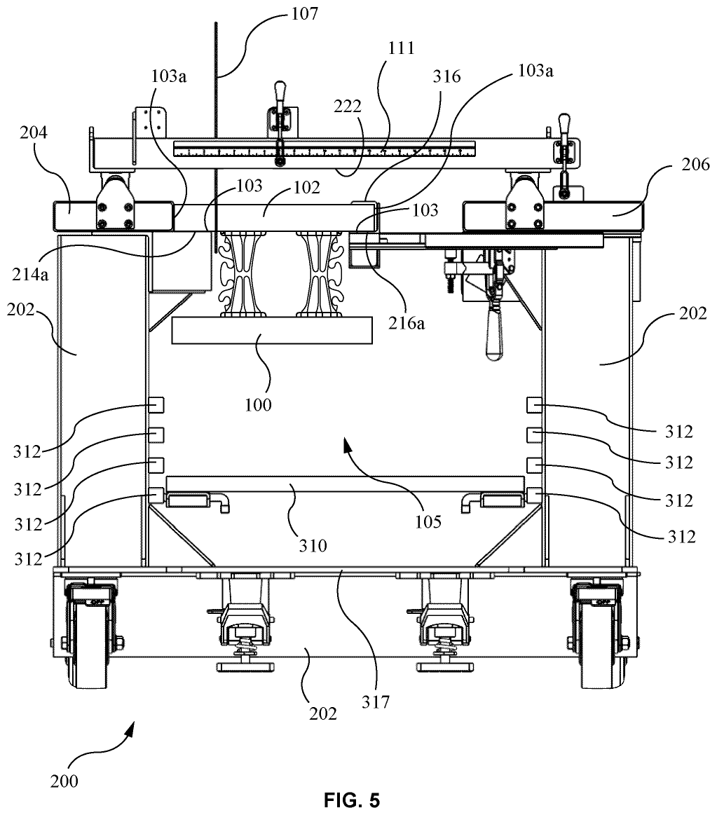

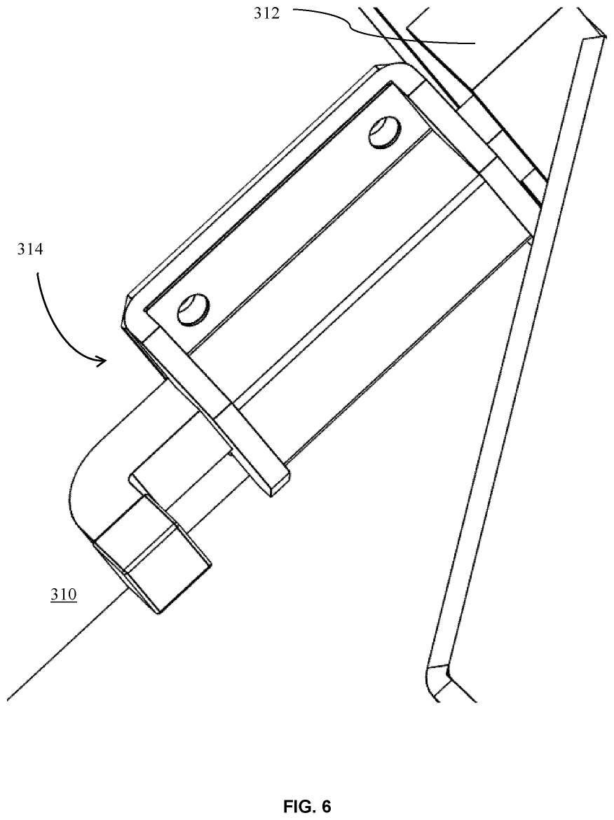

In use, a user may slide a workpiece 100 (such as a structured workpiece 100, including an ICF block 100), into the interior space 105 of the apparatus 200, while the saw 107 of the saw assembly is off (or, e.g., even before a saw assembly is releasably attached to the apparatus 200), and the second support 216 may be laterally adjusted beforehand so as to be appropriately spaced apart from the first support 214 such that both the first support 214 and the second support 216 support at least portions of respective edges 103 of the workpiece 100 (such as by their upper surfaces 214a, 216a). The second support 216 may then be further laterally adjusted until the workpiece 100 is secured between the second support 216 (such as a vertical face 216b thereof) and the interior edge 204a, as shown in FIG. 5. The workpiece 100 may then be secured in place (as described below) and once stationary within the interior space 105, the workpiece 100 may be cut by the saw 107 of the saw assembly, without requiring feeding of the workpiece 100 by a user, or by the control of roller carriages, for example, to move the work piece along during the cutting operation, and so it is expected that the presently described aspects may provide a less complex solution that is safer for users who would not be required to feed a workpiece 100 into the apparatus 200 during a cutting operation. It is also expected that because the workpiece 100 may remain stationary during cutting, and is not required to be fed through the apparatus 200 from one end, and out the other end, during a cutting operation, the apparatus 200 may not require as large of a physical space in which to operate it as would be required for known table saws.

The apparatus 200 may further comprise a locking assembly 210 for releasably locking the second support 216 in either the retracted position or any of the plurality of extended positions. In some aspects, the locking assembly 210 may comprise a clamp assembly 210 mounted below and along at least a portion of the length of the second beam 206. At least a portion of the clamp assembly 210 may project into the interior space 105 opposite the support beam 214. The second support 216 may be open at least at one longitudinal end 109 thereof (see, e.g., FIG. 2A) and may, for example, be closed off at the other longitudinal end thereof, such as by a stopper 316 (see, e.g., FIGS. 2B-3B and 5). The second support 216 may comprise a longitudinal support ledge 216 (which may comprise, e.g., an angle iron, as shown in the example shown in the figures).

An upper surface 214a of the first support 214 (which may comprise an upper surface 214a of the support beam 214) and an upper surface or horizontal face 216a of the second support 216 (e.g., a horizontal face 216a of the longitudinal support ledge 216) may lie in a common horizontal plane (such as in spaced relation), such that they may support, generally horizontally, opposing edges 103 of a workpiece 100, for example (see, e.g., FIG. 5). Referring to FIG. 1, each panel 102, 104 of the ICF block 100 comprises a lateral top edge 103 along its length and a lateral bottom edge 103 along its length. The ICF block 100, when turned on its side, as shown in FIG. 1B, may be hung or suspended from the edges 103 of one of the panels 102, 104, as shown, e.g., in FIG. 5. An ICF block 100 may be inserted into the interior space 105 of the apparatus 200 by sliding the edges 103, or portions thereof, of one of the panels 102, 104 along the upper surfaces 214a, 216a of the first support (e.g., support beam) 214 and the second support (e.g., horizontal face 216a of the longitudinal support ledge) 216 such that the ICF block 100 is suspended substantially within the interior space 105 of the apparatus 200 by one of the panels 102, 104.

The locking assembly 210 (such as a clamp assembly 210) may provide for locking (such as by clamping) of the workpiece 100 in an appropriate position for cutting. That is, after inserting the workpiece 100 into the interior space 105 of the apparatus 200, by sliding or placing the edges 103 of the workpiece 100 atop the first support 214 (such as the upper surface 214a of the first support 214, or of the support beam 214) and the second support 216 (such as the horizontal face 216a of the second support 216, or of the longitudinal support ledge 216), the workpiece 100 may be pushed by the second support 216 as the second support 216 is moved into an extended position, thereby urging the entire workpiece 100 laterally over the first support 214 (e.g., the upper surface 214a of the support beam 214) toward the first beam 204 until lateral edges 103a of the workpiece 100 abut both the first beam 204 (such as an interior edge 204a of the main frame 202 or the first beam 204) and the second support 216 (such as a vertical face 216b of the second support 216 or the longitudinal support ledge 216 (see, e.g., FIG. 2A)), after which the workpiece 100 may be substantially locked or constrained therebetween (e.g., by the locking assembly 210, such as a clamp assembly 210 clamping in place the second support (e.g., longitudinal support ledge) 216), with edges 103 of the workpiece 100 at rest atop the first support 214 (e.g., the upper surface 214a of the first support 214, or of the support beam 214) and the second support 216 (e.g., the horizontal face 216a of the second support 216 or of the longitudinal support ledge 216). The locking assembly 210 (e.g., a clamp assembly 210) may be formed from metal in some example aspects, and may comprise any known locking device(s) suitable for maintaining the second support 216 in place during the cutting of a workpiece 100.

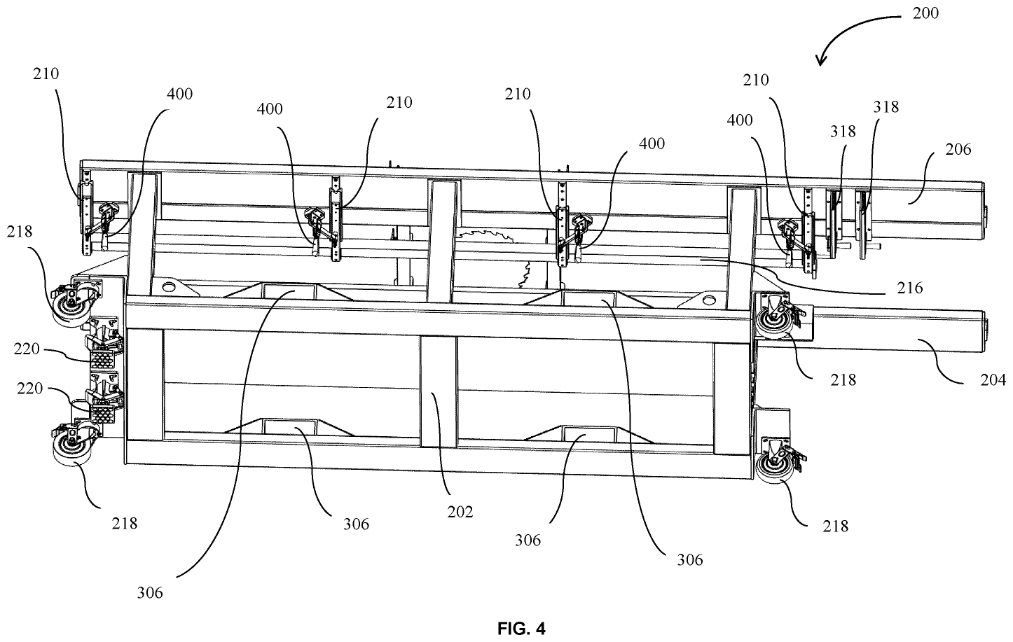

For example, the locking assembly 210 may comprise a clamp assembly 210 that may include one or more hold-down clamps 400 capable of swivelling for positioning the clamps 400 to clamp the second support 216 (e.g., the longitudinal support ledge 216) in place, as shown most clearly in FIG. 4. Any suitable mechanisms may be utilized for moving the second support 216 (e.g., the longitudinal support ledge 216), including motorized means using electric power. For example, as shown in FIG. 2B, extendable member(s) 224, which are attached to the second support 216 (e.g., the longitudinal support ledge 216), such as to a lower surface of the second support 216, may be received within respective extendable member track(s) 226 (which may be attached to the main frame 202, such as to the second beam 206 thereof) and may be translatable therein (such as by way of bearings) for moving the second support 216 (e.g., the longitudinal support ledge 216) from the retracted position to any extended position.

As described above, the second support 216 (e.g., the longitudinal support ledge 216) may be moved from its retracted position to any of a number of extended positions between the retracted position and the first support (such as the support beam) 214. The extended position of the second support 216 (e.g., the longitudinal support ledge 216) for any given workpiece 100 may comprise that position at which the second support 216 (e.g., the longitudinal support ledge 216) and the first beam 204 (such as by the interior edge 204a) abut lateral edges 103a of the workpiece therebetween (or at least that position at which the first and second supports 214, 216 support at least portions of the first and second edges 103 of the workpiece 100, even where the second support 216 (e.g., the longitudinal support ledge 216) and the first beam 204 (such as by the interior edge 204a) do not abut lateral edges 103a of the workpiece 100 therebetween, although it will be appreciated that greater stability during cutting would be achieved where the second support 216 (e.g., the longitudinal support ledge 216) and the first beam 204 (such as by the interior edge 204a) abut lateral edges 103a of the workpiece 100 therebetween to substantially constrain or lock the workpiece 100 in place during cutting).

The apparatus 200 may further comprise a translatable frame 300 for releasably supporting a saw assembly such that at least a portion of a saw 107 of the saw assembly extends below the translatable frame 300 and into the interior space 105. The translatable frame 300 may be translatably engaged with the track(s) 208 (such as the first track 208a and the second track 208b) such that a saw assembly supported by the translatable frame 300 is translatable longitudinally over the interior space 105. It may be that the translatable frame 300 is releasably clamped to at least one of the tracks 208. As shown, an additional locking assembly 302 (such as clamps 302) may secure the translatable frame 300 in place, such as to the main frame 202 (e.g., to the second beam 206 or the track 208b thereof, or to any other suitable portion of the apparatus 200) to, for example, maintain the translatable frame 300 stationary during transport of the apparatus 200.

The saw 107, when activated and translated longitudinally over the interior space 105 via the translatable frame 300, cuts the workpiece 100 while at least portions of the first and second edges 103 of the workpiece 100 are at rest upon the first support 214 and the second support 216.

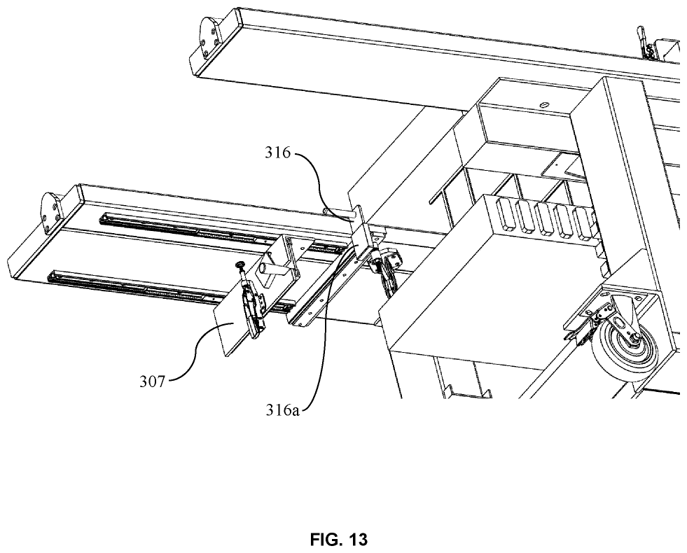

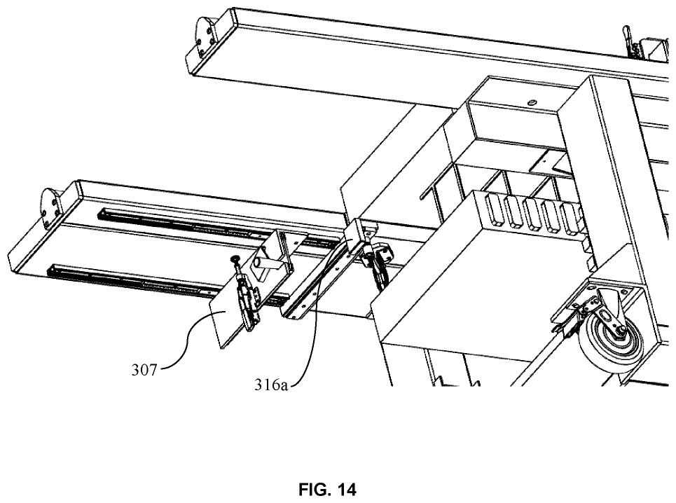

The stopper 316 may be removeable, and/or may be moveable between a stopping position (shown, e.g., in FIGS. 2A-3B and 5), at which the stopper 316 prevents movement (e.g., rearward) of a workpiece 100 beyond the stopper 316 when the workpiece 100 is moved longitudinally over the first support 214 and the second support 216) and an open position at which the stopper 316 does not prevent longitudinal movement (e.g., rearward) of a workpiece 100 over the first support 214 and the second support 216 beyond the stopper 316. The open position may comprise, for example, removing the stopper 316 (see, e.g., FIGS. 13 and 14, in which example the stopper 316 comprises a plate insertable into a stopper pocket 316a (both of which may be metal, for example), the stopper 316 shown in its stopping position in FIG. 13 in which the stopper 316 has been inserted into the stopper pocket 316a, and the stopper 316 shown in its open position in FIG. 14 in which the stopper 316 has been removed from the stopper pocket 316a). The stopper 316, in combination with the locking assembly 210, may serve to arrest or substantially arrest the workpiece 100 in place both laterally and, during a cutting operation in which the saw 107 is moved towards the stopper 316, longitudinally. It will be appreciated that the stopper 316 may comprise other configurations or types suitable for preventing, and not preventing, longitudinal movement of the workpiece 100 over the first support 214 and the second support 216 beyond the stopper 316.

In some aspects, the apparatus 200 may further comprise a saw assembly frame 304 for releasably securing the saw assembly to the translatable frame 300. The saw assembly frame 304 may be supported by, and in some aspects (and as shown in the figures), substantially within, the translatable frame 300. Dimensions of the saw assembly frame 304 may be adjustable, laterally and in some aspects, longitudinally (along with longitudinal adjustment of the translatable frame 300, in aspects where the translatable frame 300 is longitudinally adjustable) to accommodate different saw assembly sizes. Alternatively, the saw assembly frame 304 and/or the translatable frame 300 may be dimensioned to accommodate many different saw assemblies, or may be custom-made to accommodate any particular saw assembly. In some implementations, the saw assembly frame 304 may be designed to secure in place a 16″ circular saw, such as, for example, the 16 5/16^{th} inch magnesium Worm Drive Skilsaw™ marketed by Skil™ of Naperville, Illinois, sometimes marketed as Super Sasquatch™. Other size saw assemblies may be secured within the saw assembly frame 304 in other implementations.

The saw assembly frame 304 may be structured to position the saw assembly such that the saw assembly sits in and/or on the saw assembly frame 304 such that the blade or saw 107 of the saw assembly extends downward into the interior space 105, in some aspects between sides of the translatable frame 300. The vertical plane of the saw 107 may be aligned parallel to the longitudinal axis of the apparatus 200, as shown in FIG. 5, such that as the translatable frame 300 translates longitudinally (such as by gliding, rolling or sliding, as examples only), such as along the tracks 208, the saw 107 traces a cutting plane longitudinally through at least a portion of the interior space 105 between the first beam 204 and the second beam 206 of the main frame 202.

In some aspects, a lateral position of the saw assembly frame 304 may be adjustable (such as within the translatable frame 300, and such as between the first track 208a and the second track 208b) to adjust a lateral position of the saw assembly over the interior space 105 when the saw assembly is releasably secured to the saw assembly frame 304. In some aspects, the saw assembly frame 304 may be moveable so as to laterally move the saw 107 of a releasably attached saw assembly between the interior edge 204a of the main frame 202 (such as of the first beam 204) and the vertical face 216b of the second support 216 (such as the longitudinal support ledge 216). In this way, a user of the apparatus 200 may adjust the lateral position of the saw 107 and the vertical cutting plane thereof.

In some aspects, the translatable frame 300 may include one or more measure(s) 111 to indicate to a user the lateral position of the saw 107 with respect to the workpiece 100. The measure(s) 111 (e.g., ruler(s)) may comprise measurement markings on a front and/or rear face of the translatable frame 300 (such that the measurement markings extend width-wise across the apparatus 200, as shown in one example in FIG. 5), and the measurement markings may begin at a position that is vertically aligned with the interior edge 204a of the first beam 204, to assist in adjusting the location of the saw 107, via lateral adjustment of the saw assembly frame 304, so as to cut a measured portion of the workpiece 100, measured from the interior edge 204a of the first beam 204.

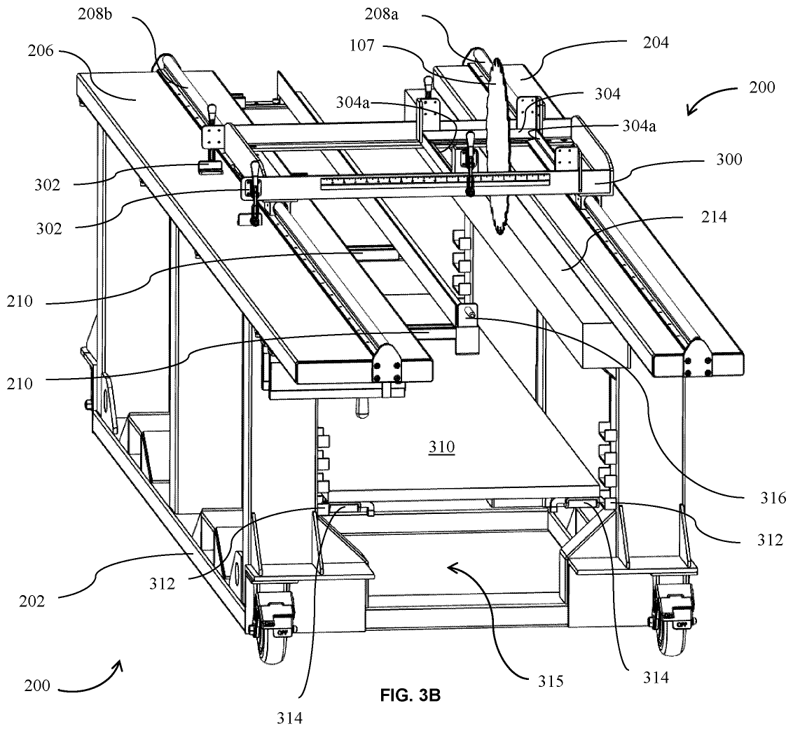

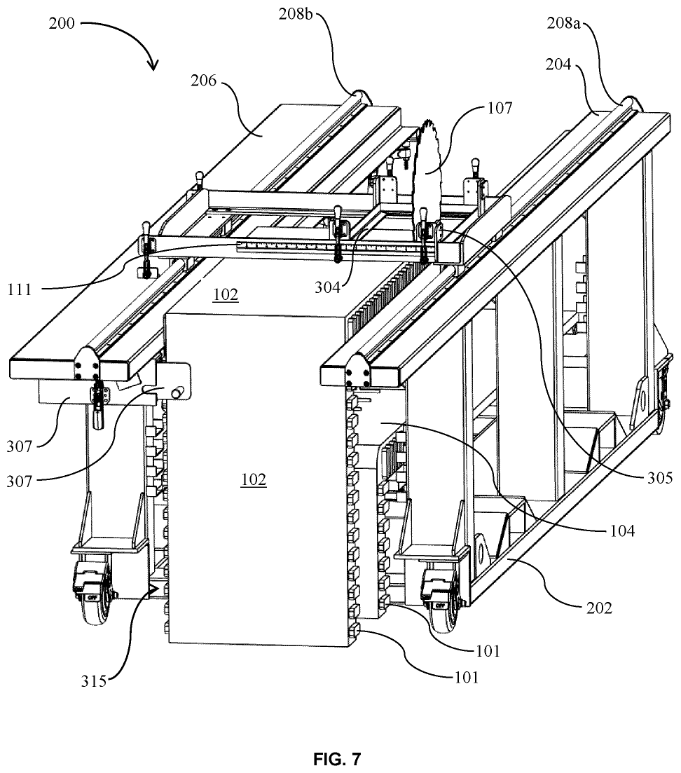

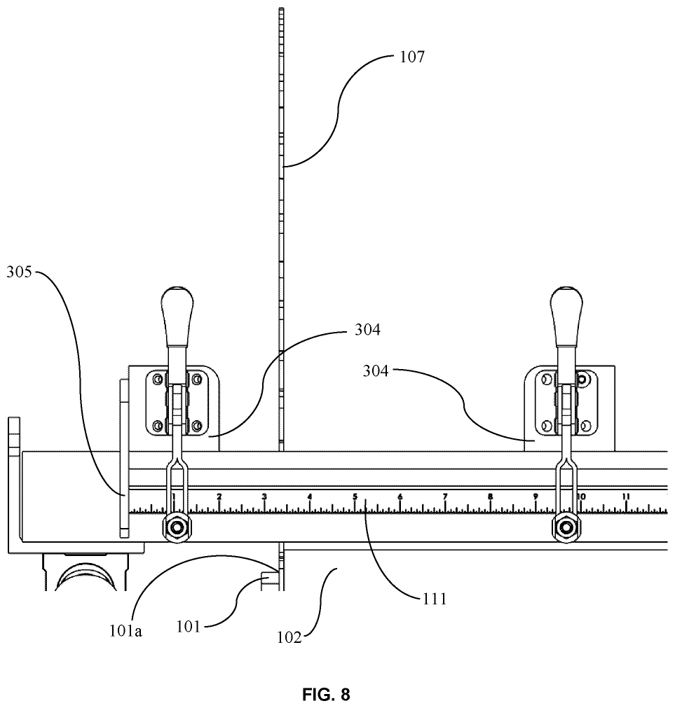

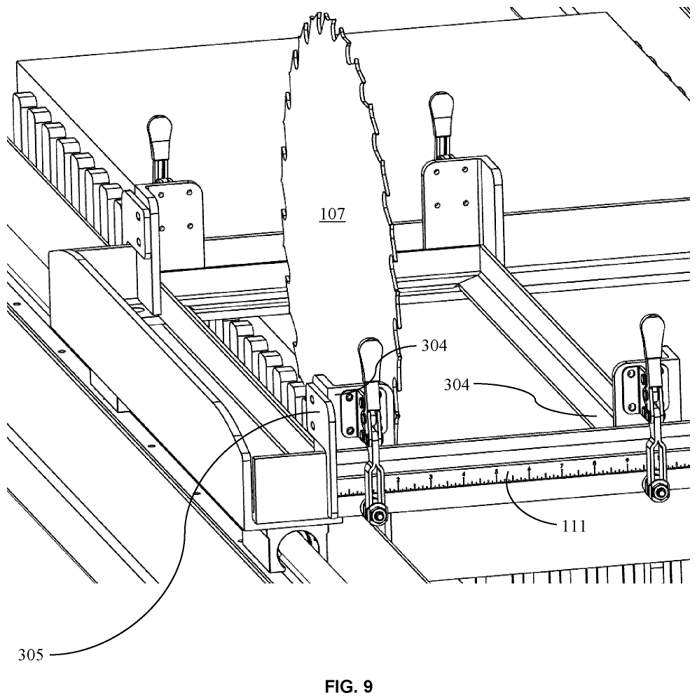

With reference to FIGS. 7-9, in another aspect, the saw assembly frame 304 may comprise one or more lateral position indicator(s) 305. Where the translatable frame 300 includes two measures 111, one on the front and one on the rear of the translatable frame 300, the saw assembly frame 304 may comprise two lateral position indicators 305, one for each measure 111. Each lateral position indicator 305 may be attached to the saw assembly frame 304 such that lateral movement of the saw assembly frame 304 similarly laterally moves the attached lateral position indicator(s) 305. Each of the lateral position indicator(s) 305 may at least partially extend over a respective measure 111 (as shown most clearly in FIGS. 8 and 9) to indicate to a user the lateral position of the lateral position indicator(s) 305 with respect to the respective measure(s) 111. As shown most clearly in FIG. 8, a lateral position indicator 305 may be positioned such that when the lateral position indicator 305 is aligned with the zero mark on the corresponding measure 111 (“the zero position”), the saw 107 of the saw assembly is positioned to cut along the bases 101a of the protrusions 101 of a panel 102, 104 of an ICF block 100. This may be necessary where, e.g., an ICF block 100 is required for the base of a wall or the top of a wall, where the wall abuts a floor or ceiling, respectively, in which case the protrusions 101 would need to be removed to permit abutting contact between such ICF blocks 100 and the floor or ceiling. As shown in the figures, the saw 107 sits inward of lateral edges 304a (see, e.g., FIG. 3B) of the saw assembly frame 304; this is because saws 107 of, e.g., portable circular saws, sit inward of the lateral edges of base plates thereof, and the saw assembly frame 304 may support such base plates. As such, while a lateral position indicator 305 that is aligned with the zero mark on the corresponding measure 111 may not be aligned with an edge of a workpiece 100 (such as the edge of a panel 102, 104 of an ICF block 100), a user could still cut off a desired amount of a workpiece 100 by moving the lateral position indicator 305 to the desired measurement on the measure 111 (e.g., if a user were to move the lateral position indicator 305 to the 3″ measurement on the measure 111, then the saw 107 would similarly move 3 inches and when cutting the workpiece 100, the workpiece 100 would be cut 3 inches in from its edge (despite that the saw 107 may be aligned with another measurement on the measure 111; e.g., in the example of FIG. 8, the saw 107 is 3.5″ in from the edge of the lateral position indicator 305, and so moving the lateral position indicator 305 to the 3″ measurement mark on the measure 111 would move the saw 107 to the 6.5″ measurement mark on the measure 111, although the workpiece 100 would only be cut 3 inches in from its edge). In some aspects, the translatable frame 300 may comprise a lateral stopper (not shown) to prevent the lateral position indicator(s) 305 from moving past the zero position.

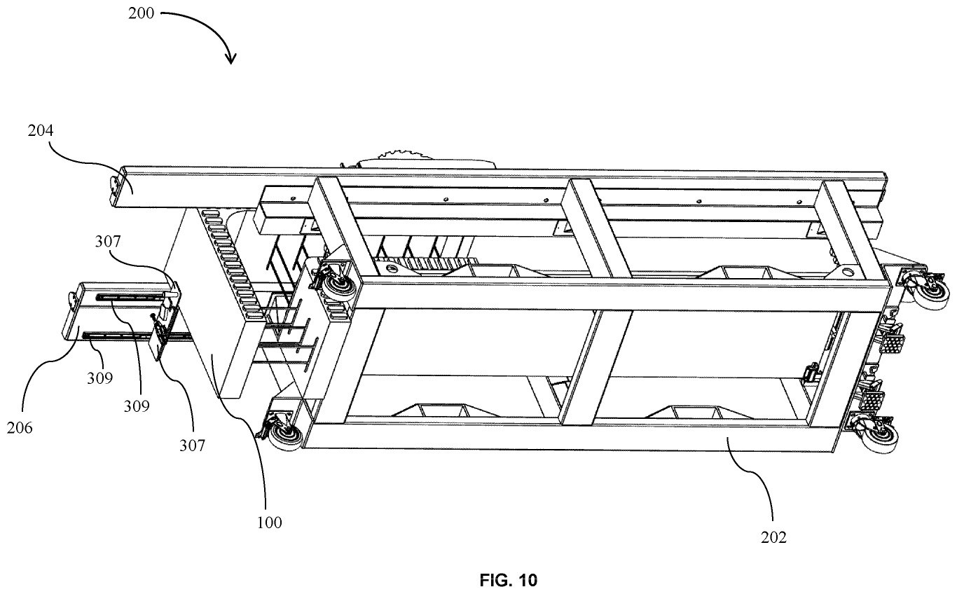

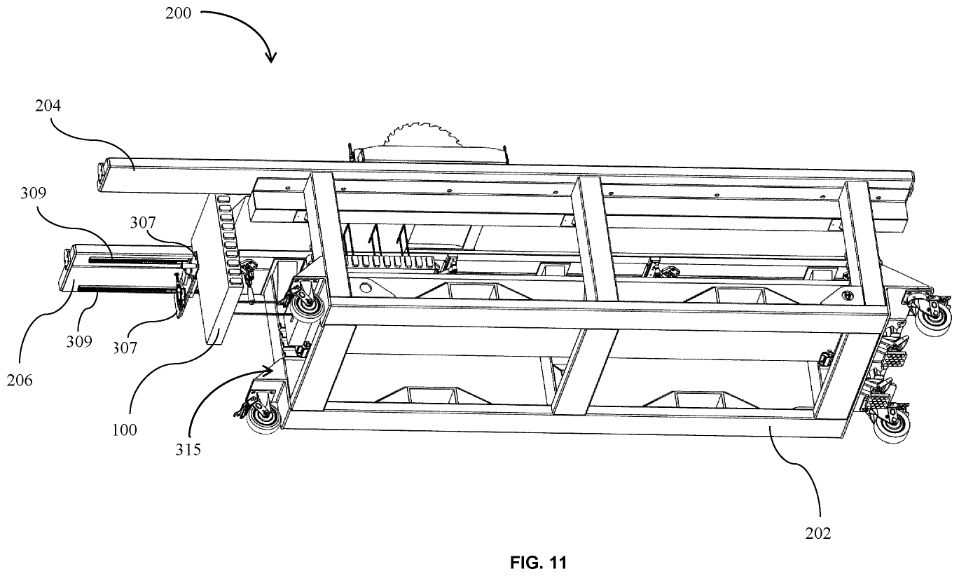

In some aspects, the apparatus 200 may be used to cut workpieces 100 having non-linear shapes, such as ICF blocks 100 having bends at least at one end thereof, including ICF blocks 100 having 90° bends at one end, as shown in FIGS. 7, 10 and 11. In such cases, it may be necessary to move the stopper 316 to its open position (shown, e.g., in FIG. 14) such that the workpiece may be slid onto or placed atop the first and second supports 214, 216 from the rear of the apparatus 200, so that a downward extending portion of the workpiece 100 (such as of the ICF block 100 shown in FIGS. 7, 10 and 11) may be positioned in the open space 315 between the rear upright legs or posts 202b (see, e.g., FIGS. 3B and 7), if required. For example, in the examples shown in FIGS. 7 and 10, the ICF block 100 has a downward extending portion that extends into the open space 315, whereas in the example shown in FIG. 11, the downward extending portion of the ICF block 100 does not extend into the open space 315. The corresponding area on the front side of the apparatus 200 may be occupied by a cross member 317 (which may comprise a part of the base 202a of the main frame 202), which may provide added rigidity to the main frame 202 and further, provide a structure to which the braking assembly 220 (described in further detail, below) may be attached (see, e.g., FIGS. 2B and 5).

In order to prevent longitudinal movement of the workpiece 100 rearward (i.e., towards the left in FIGS. 10 and 11) during cutting of the workpiece 100 from front to rear with the stopper 316 in its open position, the apparatus 200 may further comprise a translatable stopper 307 (which may be translatably attached to the main frame 202, such as to the second beam 206 of the main frame 202) such that the translatable stopper 307 is translatable longitudinally (such as along the main frame 202) and lockable in various longitudinal positions, and may prevent longitudinal movement of the workpiece 100 over the first support 214 and the second support 216 beyond the translatable stopper 307, as described in further detail below. For example, FIG. 10 shows the translatable stopper 307 translated longitudinally more rearward than shown in FIG. 11, to accommodate an ICF block 100 having a wider space between panels 102, 104 than that of the ICF block 100 shown in FIG. 11, whereas in FIG. 11, the translatable stopper 307 is moved less rearward than shown in FIG. 10, to accommodate an ICF block 100 having a space between panels 102, 104 that is not as wide as that of the ICF block shown in FIG. 10.

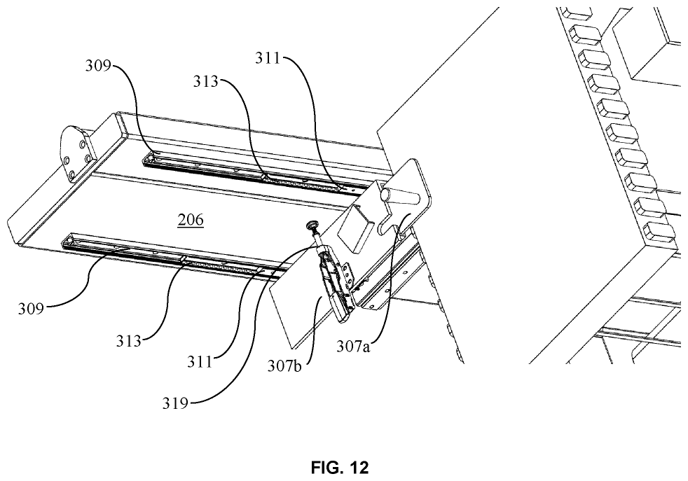

The translatable stopper 307 may be moveable between (i) a translatable stopper stopping position at which the translatable stopper 307 prevents the longitudinal movement (e.g., rearward) of the workpiece 100 over the first support 214 and the second support 216 beyond the translatable stopper 307 (and which is shown, e.g., in FIGS. 7 and 10-12), and (ii) a translatable stopper open position at which the translatable stopper 307 does not prevent longitudinal movement (e.g., rearward) of the workpiece 100 over the first support 214 and the second support 216 beyond the translatable stopper 307 (and which is shown, e.g., in FIGS. 13 and 14). In the specific example shown in the figures, the translatable stopper 307 comprises a translatable stopper plate 307a slidably received within a translatable stopper pocket 307b (see, e.g., FIG. 12), both of which may be metal, for example, although it will be appreciated that the translatable stopper 307 may comprise other configurations or types suitable for preventing, and not preventing, longitudinal movement of the workpiece 100 over the first support 214 and the second support 216 beyond the translatable stopper 307. The translatable stopper may be releasably lockable in the translatable stopper stopping position by a translatable stopper locking structure 319 (see, e.g., FIG. 12) which, as in the example shown in the figures, may comprise a releasable clamp that engages the translatable stopper 307 to the main frame 202, such as to the second beam 206, for example, although any other translatable stopper locking structure 319 capable of releasably locking the translatable stopper 307 in the translatable stopper stopping position may be used.

While the translatable stopper 307 is shown in the figures as being attached to the second beam 206, it will be appreciated that the translatable stopper 307 may be attached to any part of the apparatus 200 that would allow it to effect the preventing, and the not preventing, of longitudinal movement (e.g., rearward) of the workpiece 100 over the first support 214 and the second support 216 beyond the translatable stopper 307. For example, in other aspects, the translatable stopper 307 may be translatably attached to the first beam 204.

In some aspects, and as shown in FIGS. 2A, 3A, 3B, and 4, the apparatus 200 may comprise one or more additional stoppers 318 that are not longitudinally translatable (see, e.g., FIG. 4) in place of a translatable stopper 307. In such aspects, the apparatus 200 may comprise a plurality of the additional stoppers 318, each at a different position longitudinally along the apparatus 200, so as to accommodate workpieces 100 of different sizes (e.g., two are shown in each of FIGS. 2A, 3A, 3B, and 4). The additional stopper(s) 318 may operate as described above with respect to the translatable stopper 307 with the exception of the ability to be translated longitudinally. As such, when a workpiece 100 (such as an ICF block 100 having a 90 degree bend) is placed into the apparatus 200 upon the first and second supports 214, 216, all additional stoppers 318 may be moved to their open positions (so as not to prevent longitudinal movement of the workpiece 100 over the first support 214 and the second support 216 beyond such additional stoppers 318), except for one additional stopper 318, which may be suitably positioned to be placed into its stopping position to prevent longitudinal movement of the workpiece 100 over the first support 214 and the second support 216 beyond (such as rearward) such additional stopper 318.

As used herein, “translatable” or “translatably” comprises any suitable means for effecting translation (such as of the translatable frame 300 or the translatable stopper 307), such as slidable engagement between the translatable frame 300 and the track(s) 208, or between the translatable stopper 307 and translatable stopper track(s) 309 such as through slidable engagement between low-friction surfaces of the track(s) 208, 309 and the translatable frame 300 or the translatable stopper 307, respectively, and/or rolling of the translatable frame 300 or the translatable stopper 307 over bearings, for example. For example, as shown in FIG. 12, translatable members 311, which are attached to the translatable stopper 307, may be received within the track(s) 309 and may be translatable longitudinally therein by way of bearings 313. As used herein, “longitudinal” means a direction extending from the front of the apparatus 200 (as shown in FIG. 5) towards the opposite, rear end of the apparatus 200, and vice versa.

In some cases, if only a small portion of the structured workpiece needs to be removed along its length, the saw blade 107 may be in sufficiently close proximity to the first beam 204 that when cutting the workpiece 100, it may cut through the lateral edge 103 of the workpiece 100 supported by the support beam 214. This may involve cutting through a portion of the support beam 214, as described above. This may occur, for example, if only a small portion (e.g., an inch or half-inch) of material is to be removed from an ICF block 100, for example. As previously described, the support beam 214 may be replaceable, such as when many such cuts have been made in the support beam 214.

The apparatus 200 may further comprise a lower support 310 spanning or substantially spanning a length of the interior space 105 and in some aspects, of the main frame 202. The lower support 310 may be positioned for supporting the workpiece 100 (such as a lower one of the panels 102, 104 that is not supported by the first and second supports 214, 216), and/or for supporting falling offcuts from the workpiece 100 during a cutting operation, to help prevent such offcuts from falling to the floor. The lower support 310 may be positioned below the first and second supports 214, 216 and generally parallel to a plane defined by the first and second supports 214, 216, and within or substantially within the main frame 202. The lower support 310 may comprise a flat surface made of metal, plywood, or any other suitable material, or may, e.g., comprise netting that may be stretched taught, or may have some slack such that it dips towards its center (i.e., where the lower support 310 will not be used to support a workpiece 100 thereon), which may help to prevent offcuts from bouncing off of the lower support 310, out of the apparatus 200 and onto the floor.

In some aspects, the main frame 202 may include at least one set of brackets 312 (see, e.g., FIG. 5), which may be attached, such as in a horizontal plane, to the main frame 202, such as to corners of the main frame 202 (e.g., to corner legs or posts 202b thereof (or to more or fewer of the legs 202b, provided the lower support 310 is suitably supported, such as to all of the legs 202b) for releasably supporting the lower support 310). In some aspects, the apparatus 200 may comprise at least two such sets of brackets 312 for releasably supporting the lower support 310 at any of at least two heights corresponding to heights of the sets of brackets 312. With reference to FIG. 6, in some aspects, the lower support 310 may include a set of releasable locking structures 314 (such as loaded slide-bolt latches 314 (as shown in FIG. 6), or any other suitable releasable locking structure) positioned for releasable engagement with the set(s) of brackets 312 to suspend or support the lower support 310.

In some aspects, the interior space 105 comprises the three-dimensional space within the apparatus 200 within which the workpiece 100 may be cut as described above. In some aspects, the interior space 105 may be bound at its upper end by a horizontal plane meeting a lower edge 222 (see, e.g., FIG. 5) of the translatable frame 300, at its lower end by the lower support 310, on its left side (when viewing the apparatus 200 from the front, as shown in FIG. 5) by the interior edge 204a of the main frame 202 (such as of the first beam 204), and on its right side (when viewing the apparatus 200 from the front, as shown in FIG. 5) by the second support 216 (which includes the vertical face 216b of the second support 216 where the cut to be made is shallow enough to avoid contact with the horizontal face 216a of the of the second support 216 (such as of the longitudinal support ledge 216)). As such, the interior space 105 in such aspects is at its largest when the second support 216 is in the retracted position shown in FIG. 2A.

In some aspects, the apparatus 200, for supporting a saw assembly for cutting a workpiece 100, may comprise a main frame 202 supporting a translatable frame 300 such that the translatable frame 300 is translatable longitudinally along the main frame 202 (such as over the main frame 202, although the translatable frame 300 may be configured so as to translate longitudinally along the main frame 202 in other ways, such as within the main frame 202 or within a portion of the main frame 202). While tracks 208 have been described above as a means for translatable engagement between the main frame 202 and the translatable frame 300, the translatable frame 300 may be translatable in other ways, such as an overhead frame from which the saw assembly may hang by a single track to which it is translatably engaged, or other suitable structures for translatable engagement of the main frame 202 to the translatable frame 300. The translatable frame 300 may releasably support a saw assembly such that at least a portion of a saw 107 of the saw assembly extends below the translatable frame 300 and into an interior space 105 of the main frame 202, such that the saw assembly supported by the translatable frame 300 is translatable longitudinally over the interior space 105 with a cutting plane of the saw 107 generally parallel to a longitudinal axis of the apparatus 200.

The apparatus 200 may further comprise a first support 214 extending longitudinally and positioned for supporting at least a portion of a first edge 103 of the workpiece. For example, the first support 214 may extend longitudinally adjacent and at least partially below a side 204a of the main frame 202, and at least a portion of the first support 214 may project into the interior space 105 for supporting at least a portion of a first edge 103 of the workpiece.

The apparatus 200 may further comprise a longitudinally extending second support 216, which may be generally parallel to the first support 214, for supporting at least a portion of a second edge 103 of the workpiece 100. The second support 216 may be moveable laterally between (i) a retracted position at which the second support 216 is at its farthest from the first support 214 (at which point the second support 216 may be adjacent another side 206a (see, e.g., FIG. 2A, showing the retracted position of the second support 216 adjacent the side 206a) of the main frame 202 opposite the side 204a of the main frame 202 adjacent the first support 214), and (ii) a plurality of extended positions, each extended position between the retracted position and the first support 214.

The saw 107 when activated and translated longitudinally over the interior space 105 cuts the workpiece 100 while at least portions of the first edge 103 and the second edge 103 of the workpiece 100 are at rest upon the first support 214 and the second support 216.

The apparatus 200 may also comprise casters 218 attached at a base 202a of the main frame 202 and positioned such that the apparatus 200 is rollable over a surface. For example, the casters 218 may be attached at respective bottom corners of the base 202a of the main frame 202. In some aspects, at least two of the casters 218 may comprise swivel casters 218, for greater manoeuvrability of the apparatus 200 (for example, all casters 218 may comprise swivel casters 218). In some aspects, the apparatus 200 may comprise a braking assembly 220 attached to the main frame 202 (such as to the base 202a of the main frame 202) and moveable between a braking position for preventing or substantially preventing the apparatus 200 from moving over a surface (such as for preventing or substantially preventing the apparatus 200 from moving during a cutting operation), and a non-braking position for allowing the apparatus 200 to be moved over the surface (such as when moving the apparatus 200 to a different location). The braking assembly 220 may be positioned at one end of the main frame 202 (as shown, e.g., in FIG. 2B, such as between the casters 218), or at one or more additional sides of the main frame 202. In the example shown in the figures, the braking assembly 220 comprises a pair of floor locks with foot pads that can be lowered by depressing a kick bar or pedal lever, usually by a user's foot, so as to bring the foot pads into contact with the floor surface under pressure and weight from the apparatus 200, such that friction between the foot pads and the floor surface prevent or substantially prevent movement of the apparatus 200 during cutting operations. It will be appreciated that other known types of braking assemblies 220 may be used with the apparatus 200. In some cases, one or more of the casters 218 themselves (such as at least two of the casters 218) may include brakes 212 (see, e.g., FIG. 3A), which may improve the stability of the apparatus 200 during cutting. The brakes 212 may prevent swivelling and/or linear movement of the casters 218.

In some aspects, the apparatus 200 may comprise one or more holes 213 (see, e.g., FIG. 2A) formed in the main frame 202, such as in support gussets 308 attached to the base 202a of the main frame 202. The frame may comprise two pairs of the support gussets 308 positioned adjacent some or all of the legs 202b, such as the corner legs or posts 202b (as shown in the drawings), which may provide further structural stability to the main frame 202. The holes 213 may be for use in moving the apparatus 200 by support structure(s) passed through the one or more of the holes 213. The support structure(s) may comprise cable, wire, rope, chain, cord, and the like, of suitable strength for moving (such as by pulling or lifting) the apparatus 200, such as by a crane or other hoist, and so the holes 213 are expected to allow for the apparatus 200 to be pulled along, or to be craned or hoisted into position for use, e.g., on an upper floor in a multi-level building. A single support structure may be passed through, e.g., two holes 213, or separate support structures may be passed through separate, respective holes 213. In some aspects, the apparatus 200 may comprise at least two of the holes 213, spaced to allow for a balanced distribution of weight of the apparatus 200 when moved (e.g., lifted or pulled) by the support structure passed through the holes 213.

In some aspects, the apparatus 200, such as the main frame 202 thereof, may comprise fork pockets 306 (such as two fork pockets 306 or, as shown in the drawings, where the fork pockets 306 are formed along opposing sides of the base 202a, two pairs of fork pockets 306), which may reside in a common horizontal plane. As shown, e.g., in FIG. 4, the fork pockets 306 may be suitably spaced for receipt of forks of a forklift therethrough, for use in lifting of the apparatus 200 by a forklift.

It will be appreciated that the apparatus 200 may be used to cut workpieces 100 other than structured workpieces 100 such as ICF blocks 100, as described above. For example, the apparatus 200 may be used to cut standard lumber, such as 2×4 inch lumber, 2×6 inch lumber and 2×8 inch lumber. The apparatus 200 may be used for cutting any other materials suitable for cutting within the apparatus 200.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Any of the example aspects described herein may be combined in any suitable manner. As noted, certain adaptations and modifications of the described aspects can be made. Therefore, the above-discussed aspects are considered to be illustrative and not restrictive.

What is claimed is:

1. An apparatus for supporting a saw assembly for cutting a workpiece, the apparatus comprising:
a main frame supporting a translatable frame such that the translatable frame is translatable longitudinally along the main frame, the translatable frame for releasably supporting the saw assembly such that at least a portion of a saw of the saw assembly extends below the translatable frame and into an interior space of the main frame such that the saw assembly supported by the translatable frame is translatable longitudinally over the interior space with a cutting plane of the saw generally parallel to a longitudinal axis of the apparatus;
a first support extending longitudinally and positioned for supporting at least a portion of a first edge of the workpiece;
a longitudinally extending second support generally parallel to the first support for supporting at least a portion of a second edge of the workpiece and moveable laterally between (i) a retracted position at which the second support is farthest from the first support, and (ii) a plurality of extended positions, each extended position between the retracted position and the first support;
wherein the saw when activated and translated longitudinally over the interior space cuts the workpiece while the at least the portion of the first edge and the at least the portion of the second edge of the workpiece are at rest upon the first support and the second support.

2. An apparatus for supporting a saw assembly for cutting a workpiece, the apparatus comprising:
a main frame supporting a first track and a second track, the first track and the second track spaced apart from one another;
a first support extending adjacent at least a portion of a length of the first track, at least a portion of the first support projecting into an interior space of the main frame for supporting at least a portion of a first edge of the workpiece, the first support adjacent and at least partially below an interior edge of the main frame;
a second support generally parallel to the first support and extending adjacent at least a portion of a length of the second track, the second support for supporting at least a portion of a second edge of the workpiece and moveable laterally between (i) a retracted position at which the second support is farthest from the first support, and (ii) a plurality of extended positions, each extended position between the retracted position and the first support;
a locking assembly for releasably locking the second support in either the retracted position or any of the plurality of extended positions; and
a translatable frame for releasably supporting the saw assembly such that at least a portion of a saw of the saw assembly extends below the translatable frame and into the interior space, the translatable frame translatably engaged with the first track and the second track such that the saw assembly supported by the translatable frame is translatable longitudinally over the interior space; wherein the saw when activated and translated longitudinally over the interior space cuts the workpiece while the at least the portion of the first edge and the at least the portion of the second edge of the workpiece are at rest upon the first support and the second support.

3. The apparatus of claim 2 wherein the workpiece is an ICF (insulating concrete form) block.

4. The apparatus of claim 2 further comprising a saw assembly frame for releasably securing the saw assembly to the translatable frame.

5. The apparatus of claim 4, wherein a lateral position of the saw assembly frame is adjustable to adjust a lateral position of the saw assembly over the interior space when the saw assembly is releasably secured to the saw assembly frame.

6. The apparatus of claim 5 wherein the translatable frame includes one or more measure(s) to indicate to a user the lateral position of the saw with respect to the workpiece.

7. The apparatus of claim 6 wherein the saw assembly frame comprises one or more lateral position indicator(s), each said one or more lateral position indicator(s) attached to the saw assembly frame such that lateral movement of the saw assembly frame similarly laterally moves the attached one or more lateral position indicator(s), each said one or more lateral position indicator(s) at least partially extending over a respective one of said one or more measure(s) to indicate to the user the lateral position of the lateral position indicator(s) with respect to the respective one or more measure(s).

8. The apparatus of claim 2 wherein the first support comprises a support beam that is formed from a material that is cuttable by the saw.

9. The apparatus of claim 8 wherein the support beam is replaceable.

10. The apparatus of claim 2 wherein the main frame further comprises fork pockets spaced for receipt of forks of a forklift therethrough.

11. The apparatus of claim 2 further comprising a braking assembly attached to the main frame and moveable between a braking position for substantially preventing the apparatus from moving over a surface during a cutting operation, and a non-braking position for allowing the apparatus to be moved over the surface.

12. The apparatus of claim 2 further comprising one or more holes formed in the main frame for use in moving the apparatus by support structure(s) passed through the one or more holes.

13. The apparatus of claim 12 comprising at least two of the one or more holes, the at least two of the one or more holes spaced to allow for a balanced distribution of weight of the apparatus when moved by the support structure(s) passed through the at least two of the one or more holes.

14. The apparatus of claim 2 further comprising a lower support spanning or substantially spanning a length of the interior space and positioned for supporting offcuts from the workpiece.

15. The apparatus of claim 14 further comprising at least one set of brackets for releasably supporting the lower support.

16. The apparatus of claim 15 comprising at least two of the at least one set of brackets for the releasably supporting the lower support at any of at least two heights corresponding respectively to heights of the at least two of the at least one set of brackets.

17. The apparatus of claim 2 further comprising a stopper at one longitudinal end of the second support for preventing longitudinal movement of the workpiece over the first support and the second support beyond the stopper.

18. The apparatus of claim 17 wherein the stopper is moveable between (i) a stopping position at which the stopper prevents the longitudinal movement of the workpiece over the first support and the second support beyond the stopper, and (ii) an open position at which the stopper does not prevent longitudinal movement of the workpiece over the first support and the second support beyond the stopper.

19. The apparatus of claim 2 further comprising a translatable stopper translatably attached to the main frame such that the translatable stopper is translatable longitudinally along the main frame, the translatable stopper for preventing longitudinal movement of the workpiece over the first support and the second support beyond the translatable stopper.

20. The apparatus of claim 19 wherein the translatable stopper is moveable between (i) a translatable stopper stopping position at which the translatable stopper prevents the longitudinal movement of the workpiece over the first support and the second support beyond the translatable stopper, and (ii) a translatable stopper open position at which the translatable stopper does not prevent longitudinal movement of the workpiece over the first support and the second support beyond the translatable stopper, wherein the translatable stopper is releasably lockable in the translatable stopper stopping position.
